(19) United States
(12) Patent Application Publication
(10) Pub. No.: US 2021/0351651 A1
(43) Pub. Date: Nov. 11, 2021

(54) ELECTRICAL MACHINE

(71) Applicant: AUDI AG, Ingolstadt (DE)

(72) Inventor: Korbinian WEBER, Ingolstadt (DE)

(73) Assignee: AUDI AG, Ingolstadt (DE)

(21) Appl. No.: 17/283,694

(22) PCT Filed: Oct. 24, 2019
(86) PCT No.: PCT/EP2019/078997

§ 371 Date: Apr. 8, 2021

(30) Foreign Application Priority Data
Nov. 7, 2018 (DE) 10 2018 218 962.5

(51) Int. Cl. H02K 3/14; H02K 3/28; H02K 3/48; H02K 15/04; H02K 15/06

(52) U.S. Cl. CPC H02K 3/14; H02K 3/28; H02K 15/064; H02K 15/0421; H02K 3/48

(57) ABSTRACT

An electrical machine, including a winding carrier, which has a multiple grooves and bears at least one winding. Each winding is formed by a conductor having multiple groove portions, which are led through respective grooves of the winding carrier and conductively connected by connection portions of the conductor that lie outside of the grooves; when current flows through the conductor in question from a first connection point to a second connection point of the winding in question, the current is led about an axis of rotation of the electrical machine with a first direction of revolution in all the connection portions that lie in a first conductor portion of said conductor, which first conductor portion includes multiple connection portions, and with a second direction of revolution opposite the first direction of revolution in all the connection portions that lie in a second conductor portion of said conductor.

The invention relates to an electrical machine comprising a winding carrier which has multiple grooves and carries at least one winding, wherein the winding is formed by a respective conductor having multiple groove portions, each of which being led through one of the grooves of the winding carrier and conductively connected by connection portions of the conductor that lie outside the grooves. In addition, the invention relates to a motor vehicle and a method for producing at least one winding for an electrical machine.

In electrical machines, for example in motors or generators, a stator with coils attached thereto is typically used to drive a rotor through temporally variable energization of the coils or to convert a temporally variable magnetic field which occurs due to a rotation into an inductor current. For example, a cylindrically shaped winding carrier can be used which has multiple grooves extending in the axial direction, through which grooves a conductor forming the coils is guided. It is in principle possible to wind separate windings around each of the coil teeth which define the grooves. But it can be advantageous to guide a continuous conductor in a meandering manner through multiple grooves, as is known, for example, from document EP 1 708 338 A1.

In electrical machines having a high power density, for example drive machines for motor vehicles, a so-called hairpin design is commonly used today to manufacture such windings meandering through grooves. A profile wire, mostly a rectangular wire, is first bent into a U-shape, that is, into the shape of a hairpin. The legs of this hairpin are then arranged in a circular shape and inserted into the grooves of a laminated stator core. The free ends of the respective hairpin are in the next step twisted by a defined angle concentrically to the stator axis or axis of rotation of the electrical machine. All ends which are located on a respective diameter, that is, on a specific layer in the grooves, are alternately twisted clockwise and counterclockwise. This is also called “twisting.” Adjacent ends are welded together. Depending on the winding scheme, jumpers are placed on the winding head and welded together with respective ends of hairpins in order to connect the hairpins into an overall winding. Optionally, the pin ends are then insulated and the entire stator is impregnated. This technology enables a high degree of automation and a high copper fill factor in the stator grooves, that is, a high ratio of copper area to groove area.

In the method described, it can be a problem that such stator manufacture is relatively inflexible. If different electrical machines, for example, for different motor classes, are to be produced, each of the electrical machine types requires building its complete own production system with specifically manufactured winding carriers, particularly laminated cores and hairpins. A modular approach in which at least parts of the production line can be used for multiple motor classes, is typically hardly implementable.

In addition, when constructing electrical machines in hairpin design, there will be many resulting intersections between conductor portions of various phases in the winding head. In electrical machines with high intermediate circuit voltages, this can result in great strain on the electrical insulation of the conductors.

It is therefore the problem of the invention to provide an electrical machine which can be manufactured in a highly automated manner, particularly using the hairpin technology mentioned above, while avoiding the disadvantages mentioned.

The problem is solved, according to the invention, by an electrical machine of the type mentioned at the outset, wherein, when current flows through the respective conductor from a first connection point to a second connection point of the respective winding, the current is led about an axis of rotation of the electrical machine with a first direction of revolution in all the connection portions that lie in a first conductor portion of said conductor, which first conductor portion comprises multiple connection portions, and with a second direction of revolution opposite to the first direction of revolution that lie in a second conductor portion of said connector, which second conductor portion comprises multiple connection portions.

It is thus proposed to reverse the direction of current at least once in the circumferential direction of the winding carrier. When tracing the conductor starting from the first connection point, the conductor thus extends in the connection portions in the first and second conductor portions in the opposite direction of revolution. As will be explained in more detail later, conducting the conductor of the winding in such a manner can make it possible that the location of the connection points at the winding carrier can largely be selected freely. This can be utilized, on the one hand, to achieve contacting of the windings with little effort by grouping the connection points of different windings or phases of the electrical machine. On the other hand, the voltage drop at intersections between windings of different phases can be reduced by a positioning the connection points or selecting the direction of revolution for windings of different phases accordingly. The design described can also make it possible that the same winding carriers can be used for different machine types, for example for electrical machines which use a different number of parallel windings per phase or machines with and without chording of the windings.

The electrical machine preferably has multiple windings. The individual windings or groups of windings can each be assigned to different phases of the electrical machine. For example, windings for three phases can be used for energizing the electrical machine with three-phase current. It can be advantageous to use multiple windings connected in parallel for each phase, for example, two or three windings. The individual windings, or at least one of the windings, can comprise multiple first and/or second conductor portions, i.e. the direction of revolution of the current in the connection portions may change multiple times. Particularly preferably, the direction of revolution of the current may change precisely once or precisely twice within the respective winding, which allows a particularly simple construction of the windings.

The first and/or the second conductor section can be led in a meandering manner at least once about the axis of rotation in the circumferential direction through the grooves of the winding carrier. It is preferred that the first and/or second conductor portion is/are led multiple times about the axis of rotation, which may result in groove portions of the same winding or of different windings, particularly of different windings of the same phase, forming a stack in the individual grooves.

One stack of multiple radially stacked groove portions can respectively be arranged in the grooves, wherein the first and/or the second conductor portion of a respective conductor extend at least from a radially outermost groove portion of a stack to a radially innermost groove portion of the one or of another stack. Each stack may include groove portions of only one conductor, but also of conductors of different windings. The first or second conductor portion can for example be led multiple times about the axis of rotation, and their groove portions can tendencially move from the radially outermost groove portion to further interior groove portions of the other stacks, such that after one or multiple times leading the first or second conductor portion about the axis of rotation, a position at the innermost position of a stack is reached.

Particularly, the transition from the first conductor portion to the second conductor portion can take place at a radially outermost groove portion of a stack or at a radially innermost groove portion of a stack. As will be explained later, reversing the direction of revolution of the current or the extension of the conductor can be achieved particularly easily there.

The conductor can comprise at least one groove portion that is connected as reversing groove portion via two connection portions to other groove portions of the conductor which are led starting from the respective reversing groove portion in the same direction in the circumferential direction of the winding carrier. In the circumferential direction of the winding carrier, grooves and portions separating the grooves of the winding carrier, such as stator teeth, can be arranged alternately. Since the connection portions which directly adjoin the reversing groove portion extend in the same direction in the circumferential direction of the winding carrier, the direction of revolution of a current led through the conductor reverses between these connection portions. This means that one of the two connection portions can be part of the first conductor portion and the other of the two connection portions can be part of the second conductor portion.

A stack of multiple groove portions stacked in the radial direction can be arranged in each groove, wherein the reversing groove portion is the radially outermost groove portion of one of the stacks and one of the connection portions which connect the reversing groove portion to other groove portions of the conductor is led radially outwards, or wherein the reversing groove portion is the radially innermost groove portion of one of the stacks and one of the connection portions which connect the reversing groove portion to the other groove portions of the conductor is led radially inwards. The connection portion led outwards or inwards can particularly be led on the inside or outside past the stack of groove portions of at least one adjacent groove or past the connection portions connected to these groove portions. The procedure described is particularly advantageous if the hairpin technology explained at the outset is used to construct the winding or windings of the electrical machine. As explained, in this method, typically all free ends of conductor hairpins that come to rest on the same radius can be bent or twisted in the same direction to connect them to free ends on an adjacent radius. The connection portion of the reversing groove portion that is led outwards or inwards can also be formed by such a free end of a hairpin, which is thus led to another radius and can easily be led into another direction than the other free ends on the radius of the reversing groove portion to achieve a reversal of the conductor path or of the current flow.

Also, two reversing groove portions can be provided in a winding, one of which being a radially outermost groove portion of a stack and one being a radially innermost groove portion of the one or another stack. In this case, the connection portion of the radially innermost reversing groove portion can be led inwards and that of the radially outermost reversing groove portion can be led outwards.

Apart from one or two reversing groove portions of the respective conductor and groove portions of the conductor which are adjacent to the connection points, all groove portions of the conductor can be connected via two connection portions to other groove portions of the conductor which, starting from the respective groove portion, are led into opposing directions in the circumferential direction. Thus a meandering path of the first or second conductor portion is implemented with simple means through the grooves having a respective direction of revolution in the circumferential direction.

The respective conductor can be formed by multiple conductor hairpins connected to each other, each of which forming two of the groove portions and one coupling portion connecting the groove portions, wherein the coupling portion forms a first connection portion for these groove portions, wherein a respective second connection portion is formed by a respective free end of the conductor hairpin, which end is bent into a direction in the circumferential direction of the winding carrier and conductively connected to a free end of another conductor hairpin. If one of the groove portions is the reverse portion, the free end is particularly also bent in the radial direction to be led radially inside and outside past the connection portions which contact the groove portions of at least one other groove. The electrical machine according to the invention can thus be produced by a method which largely corresponds to the known hairpin technology, wherein the direction of revolution of the current inside the winding is reversed due to the interconnection of the conductor hairpins with each other, particularly by using the reversing groove portions described above. Therefore, an electrical machine according to the invention can be produced relatively easily in that a known production method is modified accordingly.

It is possible that all groove portions are formed by the conductor hairpins explained above. But it is also possible that individual groove portions are formed in a different manner, for example by substantially straight conductor portions which form the respective groove portion and free ends. Respective straight conductor portions which are used in the course of constructing a slip-in coil are also called S-PINs, because the have an S-shape after twisting the free ends. Such conductor portions that are substantially straight when inserted can for example be used to move a contacting to a side of the winding carrier facing away from the free ends of the conductor hairpins.

The or a stack of multiple groove portions stacked in the radial direction can be arranged in the grooves, wherein, apart from one or two reversing groove portions of the respective conductor, the free ends of the conductor hairpins which extend groove portions arranged in the same radial position in the stacks are bent in the same direction in the circumferential direction. Thus twisting or bending the free ends of the conductor hairpins can be implemented relatively easily, since all free ends located on a specific radius are bent into the same direction in the circumferential direction.

The winding carrier can carry a first winding of a first phase of the electrical machine and a second winding of a second phase of the electrical machine, wherein those groove portions at which the first and/or second connection point of the first winding is formed is arranged on another radius with respect to the axis of rotation of the electrical machine than those groove portions at which the first and/or second connection point of the second winding is formed. It was found as part of the invention that high voltages between intersecting conductors of different phases occur only for relatively few windings or groove passages of the respective winding. Voltage peaks or excessive voltages can be specifically expected in the first windings after a connection point. Arranging the connection points of the windings of different phases on different radii can help achieve that intersections at which conductors of various electrical phases cross in the winding head are at least spaced apart from the connection points of one of the windings or one of the phases along the conductor, such that overall the maximum voltage drop between conductors at intersections can be reduced.

The winding carrier can particularly comprise windings for three phases, wherein the connection points of the different phases are arranged on different radii. It is also possible that the winding carrier carries multiple windings per phase. Since the connection points of the windings for the same phases are approximately at the same voltage level, the connection points of multiple windings of the same phase can be arranged on the same radius or at a small radial spacing.

As explained above, the current path having different directions of revolution within the same winding allows that connection points for a winding can in principle be arranged at any desired point of the winding. In this manner it is easy to implement the radial spacing of the connection points of windings of different phases explained above and thus a reduction of the strain on the insulation of the conductors.

To make contacting the windings easier, it can be advantageous if the connection points of at least the windings of the same phase, particularly however the connection points of the windings of all phases, are relatively close to each other, viewed in the circumferential direction of the winding carrier. For example, all connection points can be arranged in an angular segment of less than 90°, less than 45°, or less than 30°. Low strain on the insulation of the conductors of the windings can still be achieved by the radial spacing of connection points of the different phases as explained above.

The winding carrier can carry the or a first winding of the or a first phase of the electrical machine and the or a second winding of the or a second phase of the electrical machine, wherein, if a current flows through the respective conductor from the first connection point to the second connection point of the respective winding, the current is led in the connection portions of a first terminal portion of the conductor of the first winding in a direction of revolution about the axis of rotation of the electrical machine which is opposite to the direction of revolution with which the current is led in the connection portions of a second terminal portion of the conductor of the second winding, which includes the first connection point of the second winding. The current or the respective conductor is thus led about the axis of rotation of the electrical machine in different directions of revolution for the first and second windings, starting from the respective connection point. This can advantageously reduce voltage drop at intersections where the conductors of these windings intersect in the winding head. For example, it is possible that, due to the opposite direction of revolution, the conductors of the windings only intersect after each of the conductors was led at an angle of approximately 180° about the axis of rotation of the electrical machine. Thus the first intersection of the conductors is relatively far away from the respective connection points, such that, as described above, lower voltage differences between the conductors are expected than in the case in which this intersection were closer to the connection points. Windings of the same phase are preferably led in the same direction of revolution about the axis of rotation, starting from the connection point. If an electrical machine is used with three phases, the direction of rotation with which the winding is led about the axis of rotation can be reverse for one phase with respect to the two other phases.

In addition to the electrical machine, the invention relates to a motor vehicle which comprises an electrical machine according to the invention. The electrical machine can particularly be a drive motor of the motor vehicle.

In addition, the invention relates to a method for producing at least one winding of an electrical machine comprising the following steps:
providing a winding carrier and multiple conductor hairpins, each of which is formed from a hairpin-shaped conductor portion,
axially inserting the conductor hairpins into the winding carrier such that two groove portions of each conductor hairpin run in a respective groove of the winding carrier, and
bending the free ends of the conductor hairpins into a respective direction in the circumferential direction of the winding carrier and connecting to a free end of a respective other conductor hairpin to form the conductor from the conductor portions, wherein a free end of at least one conductor hairpin is bent in the same direction in the circumferential direction of the winding carrier into which a coupling portion connecting the groove portions of this conductor hairpin extends as well.

The method described can particularly be used to produce an electrical machine according to the invention. That groove portion of that conductor hairpin which is contacted via the free end and the connection portion, which are bent in the same direction in the circumferential direction, forms a reversing groove portion at which the direction of revolution of the current about the axis of rotation of the electrical machine changes. It can thus form the transition between the first and second conductor portions of the conductor explained above. The advantages explained above for the electrical machine according to the invention can be achieved by means of this reversal of the current or conductor path of the winding. The method can be developed further by procedural steps and features which are required to implement individual features of the electrical machine according to the invention.

Apart from one or two conductor hairpins, the free ends of the conductor hairpins of a winding can be bent against the direction of the connection portion in the circumferential direction of the winding carrier in order to lead the conductor in a meandering manner in the circumferential direction through the grooves of the winding carrier. The conductor hairpins can particularly be inserted into the winding carrier such that the groove portions are stacked in the grooves and thus arranged on different radii. The free ends which are not to be bent in the same direction as the connection portions can stay on the same radius in which the adjacent groove portion is located as well. Those free ends that are to be bent in the same direction as the connection portion can be led outwards or inwards from the region in which other free portions are located onto a separate radius. Then all free ends located on a radius can be bent or twisted in the same direction.

The free ends of the conductor hairpins can first be connected to each other, such that a closed conductor loop is formed. Then the connection between two free ends can be disconnected or a coupling portion of one of the conductor hairpins can be disconnected to form a first and a second connection point of the winding. Such an approach allows to select the positions of the connection points substantially freely. Thereby, the connection points of all windings are grouped in a specific circumferential segment and/or connection points of different phases are moved to different radii, as has been explained above with respect to the electrical machine.

Further advantages and details of the invention will be apparent from the exemplary embodiments below and the associated drawings. Wherein, schematically:

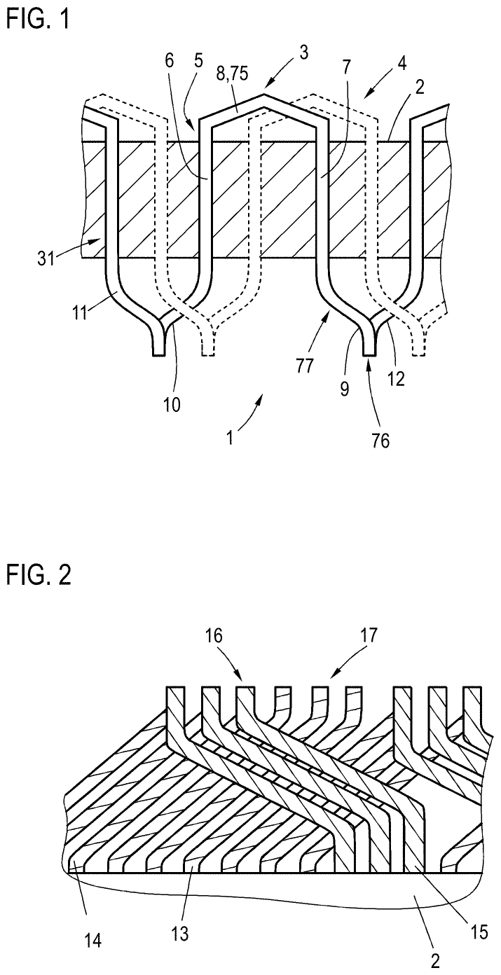

FIG. 1 shows a detailed sectional view of an exemplary embodiment of an electrical machine according to the invention, the windings of which can be produced by an exemplary embodiment of the method according to the invention,

FIG. 2 shows the shape and connection of the free ends of the conductor hairpins used in FIG. 1 for forming the winding,

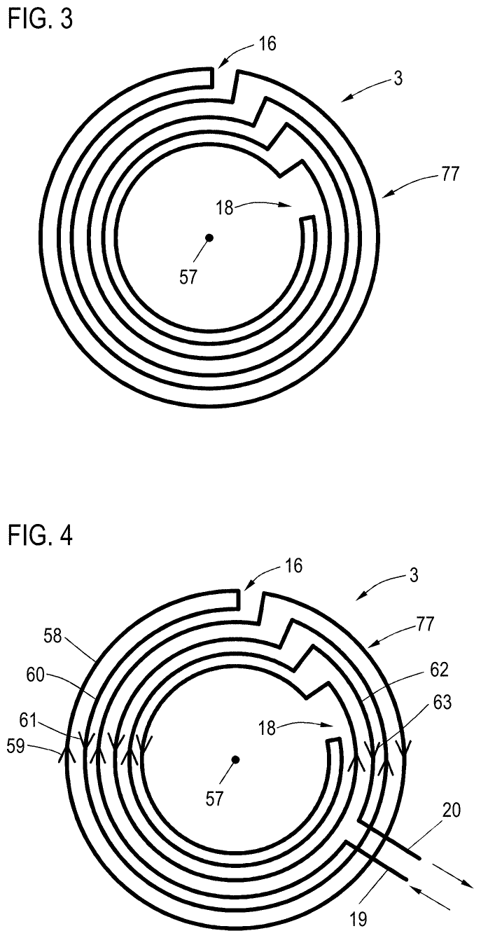

FIGS. 3 and 4 show how the conductor is led in the circumferential direction of the electrical machine in an exemplary embodiment of the electrical machine according to the invention,

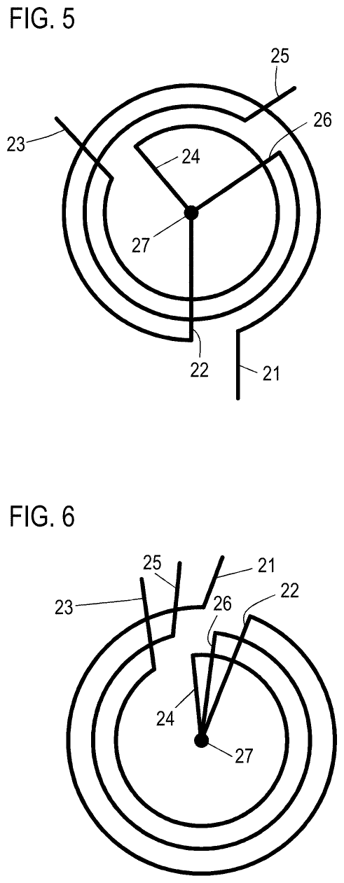

FIGS. 5 to 7 show various arrangement options for connection points of the windings of different phases in various exemplary embodiments of the electrical machine according to the invention,

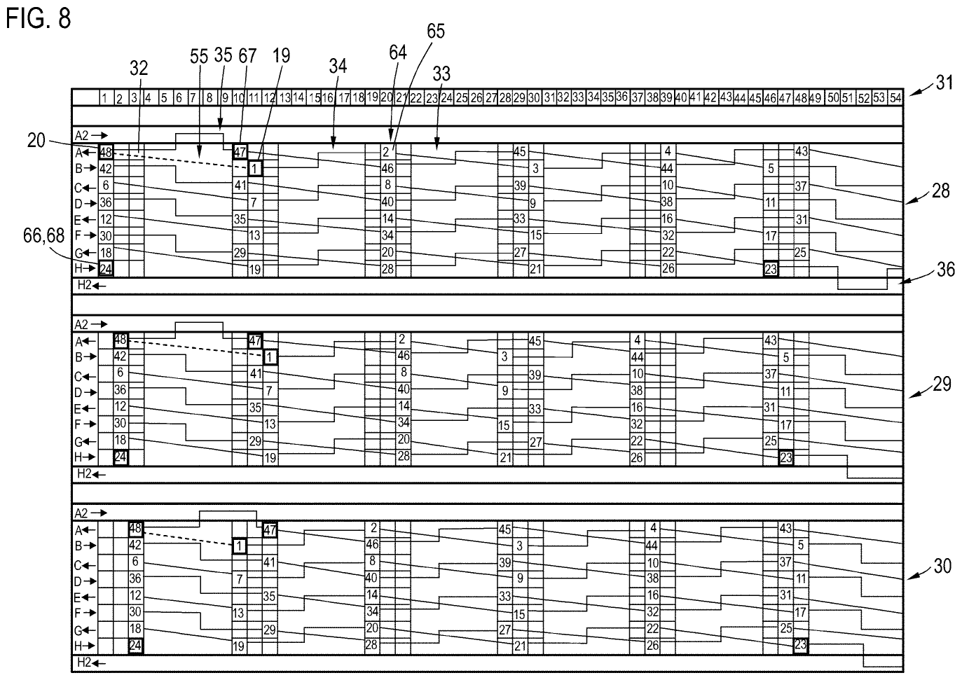

FIGS. 8 to 15 show a winding scheme for windings of various exemplary embodiments of the electrical machine according to the invention, and

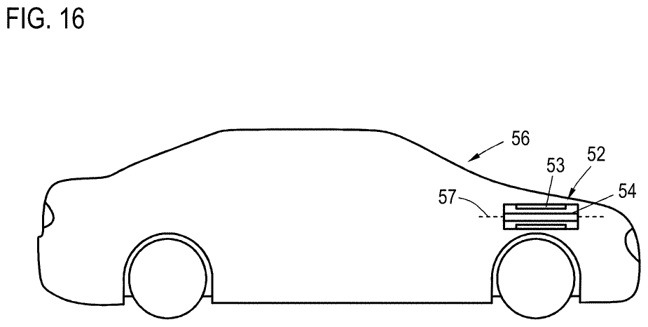

FIG. 16 shows an exemplary embodiment of a motor vehicle according to the invention.

FIG. 1 shows a detailed view of a stator 1 of an electrical machine. The stator comprises a stator carrier 2 having multiple grooves 31 and carrying multiple windings 3, 4. For reasons of clarity, FIG. 1 only shows two windings 3, 4 for a respective phase.

The windings 3, 4 in the exemplary embodiment shown are produced by a so-called hairpin method in which the conductor 77 of the windings 3, 4 is formed by conductively interconnected, e.g. welded together, conductor hairpins 5. The conductor hairpins 5 each comprise two groove portions 6, 7 and a coupling portion 8 combining the groove portions. The free ends 9, 10 of the conductor hairpins 5, which ends extend the groove portions 6, 7, initially extend the groove portions 6, 7 in a straight line, other than shown in FIG. 1, and will be bent at a later time only.

The conductor hairpins 5 of the windings 3, 4 are arranged in an annular shape and then inserted axially, that is, in a vertical direction in FIG. 1, into the winding carrier 2 which has a cylindrical shape that is shown rolled open in FIG. 1. The conductor hairpins 5 are inserted to the point where the groove portions 6, 7 are arranged in the grooves 31 and the free ends 9, 10 project on the side of the winding carrier 2 facing away from the coupling portion 8 beyond said coupling portion.

FIG. 1 shows this for reasons of clarity for just two windings 3, 4 of two phases. Typically, multiple windings per phase are used, and windings are provided for three phases. In the grooves 31, one respective stack results from multiple groove portions 6, 7. The groove portions 6, 7 thus come to rest in different planes vertically to the image surface, that is, at different radial distances from an axis of rotation of the electrical machine. The free ends 9, 10 each come to rest in the same plane or at the same radial distance from the axis of rotation, like the respective groove portion 6, 7 which they extend. Since the groove portions 6, 7 of a respective conductor hairpin 5 typically come to rest in different planes, the coupling portion extends diagonally to the image plane in FIG. 1.

The free ends 9, 10 are bent to connect the conductor hairpins 5 or the groove portions 6, 7 to a continuous conductor of the winding. This bending process is also called twisting. In this process, all free ends which lie on the same radius, that is, at the same radial distance from the axis of rotation of the electrical machine or in the same plane perpendicular to the image plane in FIG. 1, are bent in the same direction. For example, the free ends 9, 11 are bent to the right and the free ends 10, 12, which in FIG. 1 are farther away from the viewer, are bent to the left. Thus the free ends 10, 11 and 9, 12 are directly adjacent and can be conductively connected, for example, welded together.

If the connection of the conductor hairpins 5 into the conductor 77 were performed for all conductor hairpins as explained, the result would be a conductor 77 which extends over the entire length of the conductor 77 in a meandering manner in the circumferential direction of the winding carrier 2 through the grooves 31 of the winding carrier 2.

But it was found that it can be an advantage to configure the conductor 77 such that, when a current flows through the conductor 77 from a first connection point to a second connection point of the respective winding 3, 4, the current is led in a first direction of revolution in the connection portions 75, 76 formed by the coupling portions 8 or the free ends 10 and 11 or 9 and 12, which lie in a first conductor portion of this conductor 77, and in all connection portions 75, 76 which lie in a second conductor portion of this conductor 77 in a second direction of revolution, which is opposite to the first direction of revolution, about the axis of rotation of the electrical machine.

A way to achieve this with a slight modification of the procedure described above will be explained below with reference to FIG. 2. FIG. 2 exclusively shows free ends 13, 14, 15 which extend such groove portions that lie in the stacks of groove portions 6, 7 described above radially to the axis of rotation of the electrical machine at the outermost edge of the respective stack. A majority of the free ends 13, 14, as explained with reference to FIG. 1, are bent in the same direction because the associated groove portions are on the same radius. The free ends 13, 14 and the respective coupling portion 8 of the associated conductor hairpin (not shown) thus extend in different directions in the circumferential direction, which results in a meandering path of the current through the grooves 31. For example, the free end 13 at point 17 is connected to another free end (not shown) of another conductor hairpin, wherein the associated groove portion of this other free end lies on a stack plane that is radially farther inward, that is, away from the viewer in FIG. 2, which means that the other free end in FIG. 2 would be bent to the left and thus makes a connection with the free end 13, as shown in FIG. 1 for the free ends 10, 11 or 9, 12, respectively.

The free ends 15 however are bent in such a manner that they initially are led radially outwards, that is towards the viewer in FIG. 2, and then, on a separate radius outside the groove stacks or the other connection portions 13, 14, are bent to the left to contact the free ends 14 and thus to form a respective reversal point 16 for the respective winding. Particularly preferably, another reversal point can be provided for a respective winding in addition to the outer reversal point 16 described, which other point is formed by a free end that extends a groove portion lying radially on an inside edge of one of the stacks.

The resulting path of the conductor 77 if both the outer reversal point 16 and the inner reversal point 18 are implemented and all free ends are connected as explained with reference to FIG. 1, is schematically shown for the winding 3 in FIG. 3. It can be seen that the conductor 77 is formed into a conductor loop which runs multiple times about an axis of rotation 57 of the electrical machine.

As shown in FIG. 4, connection points 19, 20 can be provided at almost any point of this conductor loop to contact the winding 3. The connection points 19, 20 can either be formed in that a conductive connection is omitted for two of the free ends 9 to 12 or in that a coupling portion 8 is separated at one of the conductor hairpins 5. As will be explained in more detail later, a respective selection of the positions of the connection points 19, 20 in the circumferential direction and in the radial direction can on the one hand result in a grouping of the connection points 19, 20 of different windings 3, 4 and/or different phases. On the other hand, the connection points 19, 20 of windings of different phases can be arranged such that voltages occurring at intersecting conductors 77 of different phases are not too high.

As shown in FIG. 4, it can be achieved with the arrangement of connection points 19, 20 shown that the current flow through the conductor 77 from the first connection point 19 to the second connection point 20 first runs in a first conductor portion 58 in a first direction of revolution 59, which is clockwise, about the axis of rotation 57 of the electrical machine. After reaching the reversal point 16, the current is led through a second conductor portion 60 in a second direction of revolution 61, which is counterclockwise, about the axis of rotation 57 of the electrical machine to the second reversal point 18 to subsequently be led in a third conductor portion 62 again in the first direction of revolution 63, that is, clockwise, about the axis of rotation 57. The current is led in a meandering manner in all three conductor portions 58, 60, 62 through the grooves (not shown) of the winding carrier, wherein it is led at least once in the circumferential direction about the axis of rotation 57.

As explained, the construction of the electrical machine described makes it possible that the position of the connection points 19, 20 on the respective winding 3, 4 can substantially be selected freely in the circumferential direction and in the radial direction. FIGS. 5 to 7 show various examples of how the connection points of windings of different phases can be distributed in the circumferential direction of the winding carrier 2. For reasons of clarity, these figures each show only one winding of each phase and the windings are led only once in the circumferential direction about the axis of rotation of the electrical machine. The individual windings may of course also be configured as explained with reference to FIG. 4. A star connection is used in all three figures in which the connection points 22, 24, 26 of all three phases are shorted at the star point 27.

FIG. 5 shows an arrangement in which the connection points 21, 22 of a first phase, the connection points 23, 24 of a second phase, and the connection points 25, 26 of a third phase are offset in the circumferential direction by an angle of 120°. An advantage of such an arrangement of the connection points 21 to 26 is that intersections between the conductors of each phase are relatively widely spaced apart from at least one of the connection points 21 to 26, such that voltages occurring between adjacent conductors at these intersections are not too high. It is a problem, however, that the connection points 21 to 26 of different phases are relatively far away from each other. This makes contacting each of the connection points 21 to 26 and particularly the short-circuiting of the connection points 22, 24, and 26 at the star point 27 harder. For contacting the three phases shown in FIG. 5, a complicated jumper would be required that has to be placed upon the winding head. This makes the production of the electrical machine more complicated and could result in a higher installation space requirement.

As explained with respect to FIG. 4, it can substantially be freely selected where the respective connection points 21 to 26 are provided on the respective winding due to the configuration of the winding with one or two reversal points 16, 18 as explained above, A modification as shown in FIG. 6 is therefore easily possible, wherein all connection points 21 to 26 are grouped in a relatively small angular range in the circumferential direction to allow easier contacting of the connection points 21 to 26. Since the connection points 21, 22 of the first phase, 22, 23 of the second phase, and 25, 26 of the third phase can be placed onto different planes in radial directions, it can still be achieved that voltages occurring between intersecting conductors in the winding head are not too high, meaning that no thick insulation is required.

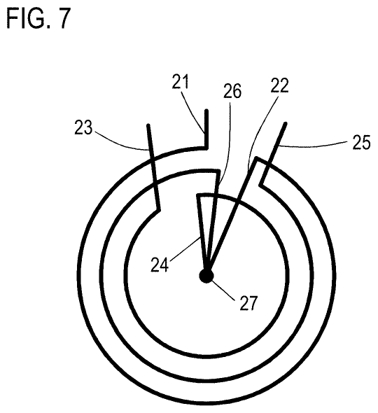

FIG. 7 shows another modification of the arrangement of the connection points 21 to 26. In this case, current is initially led counterclockwise starting from the connection point 21, 23 of the first and second phases, while it is led clockwise staring from connection point 25 of the third phase. A voltage which drops between intersecting conductors of different phases can further be reduced in this manner.

FIGS. 8 to 15 show various winding schemes by means of which the geometrical arrangement of the connection points shown in FIG. 7, that is, a grouping of all connection points in the circumferential direction, utilization of opposing directions of revolution of the three phases, and a spacing of all connection points in the radial direction, can be implemented.

The winding scheme shown in FIG. 8 illustrates the construction of three windings 28, 29, 30 of a stator of an electrical machine. The winding carrier comprises a total of 54 grooves 31, wherein the winding scheme shows a rolled-open view of these grooves and the conductor portions arranged therein. The boxes 32 each mark a respective winding layer in one groove 31, respectively. Empty boxes 32 show winding layers of other windings of the same phase. The boxes or winding layers for the other phases are not shown in FIG. 8 for reasons of clarity. The boxes identified by the numerals 1 to 48 denote groove portions of the respective winding 28 to 30, wherein the groove portions are counted along the conductor from a first connection point 19 to a second connection point 20. The letters A to H indicate the individual winding layers of the grooves. The arrows shown next to them indicate the direction into which free ends of groove portions in this winding layer are bent during twisting to connect them to other free ends. The winding layer A can be the winding layer farthest away from the axis of rotation of the electrical machine, and the winding layer H the one closest to the axis of rotation, or vice versa.

The windings 28 to 30 are formed in that multiple conductor hairpins is arranged radially and the respective groove portions are inserted axially into the grooves 31. This results in stacks 64 in the individual grooves 31, in which stacks groove portions of the same winding 28 to 30 or of different windings of the same phase are stacked. As will be explained in more detail later, groove portions of different phases can be stacked in the same stack 64 for a winding with a chording.

Since the groove portions are formed by inserting conductor hairpins, two groove portions are connected by a connection portion 33, which is formed by the coupling portion of the respective conductor hairpin. These connection portions 33 are shown as straight lines which connect two boxes in FIGS. 8 to 15. The remaining connection portions 34 are formed in that the free ends of the conductor hairpins are bent or twisted in that direction which is shown by the arrow for each winding layer A to H next to the respective letter, and are then connected. These connection portions 34 are shown as stepped lines in FIGS. 8 to 15.

The windings shown in FIG. 8 are configured such that the direction of revolution of the current flow changes when a current flows through the conductor from connecting point 19 to connecting point 20. A current fed in at connection point 19 flows in a first direction of revolution to the reversing groove portion 68, changes its direction of revolution there and is led to the second connection point 20 in this changed direction of revolution. This is achieved in that the free end which extends the reversing groove portion 68 is not bent to the right, as are all the other free ends in the winding layer H, in FIG. 8 but, as shown for the respective connection portion 36 is first led radially inwards into the layer H2 and from there to the left to the box or groove portion numbered 23. Thus both connection portions which connect the reversing groove portion 68 to the other groove portions are led in the same direction in the circumferential direction of the winding carrier.

A first conductor portion in which the current is led in a first direction of revolution, to the right in FIG. 8, extends from a radially outermost groove portion 65 of a stack 64 to a radially innermost groove portion 66 of a second stack 64. Particularly, the reversing groove portion 68 is an innermost groove portion 66 of a stack 64, such that the connected free end can easily be guided in the separate winding layer H2.

That conductor portion that leads the current in a reverse direction of revolution compared to the conductor portion discussed above also extends from a radially innermost groove portion 66 of a stack 64 to a radially outermost groove portion 67 of a second stack 64.

In addition, a connection portion 35 is provided in the windings 28 to 30, which is also formed in that a free end which is connected to the box or groove portion designated with the numeral 48 is not led to the left, as are all the other free ends of the respective winding layer A in FIG. 8, but radially into the farther outside layer A2 and from there back to the box designated with the numeral 47 or to a free end associated with the respective groove portion.

The groove portions associated with the boxes designated with the numerals 1 and 48 may also be formed by a conductor hairpin as part of the construction of the windings 28 to 30. Thus an additional connection portion 55 which is formed by the coupling portion of the respective conductor hairpin during construction. The groove portion of the box designated with the numeral 48 thus initially forms an additional reversing groove portion, the free end and coupling portion of which are led in the same direction in the circumferential direction of the winding carrier. The connection portion 55 can then be disconnected to provide the connection points 19, 20. Such a procedure is on the one hand advantageous because all windings 28 to 30 can be formed by inserting conductor hairpins, which means that no different components must be handled. In addition, the connection points 19, 20 can easily be arranged as needed at a different point of the respective winding 28 to 30, in that, after forming the conductor loop explained above, another coupling portion is disconnected or free ends are not connected or disconnected again.

Alternatively, it would also be possible not to use a conductor hairpin for the boxes identified by the numerals 1 and 48 but a linear pin to form the respective groove portions and free ends.

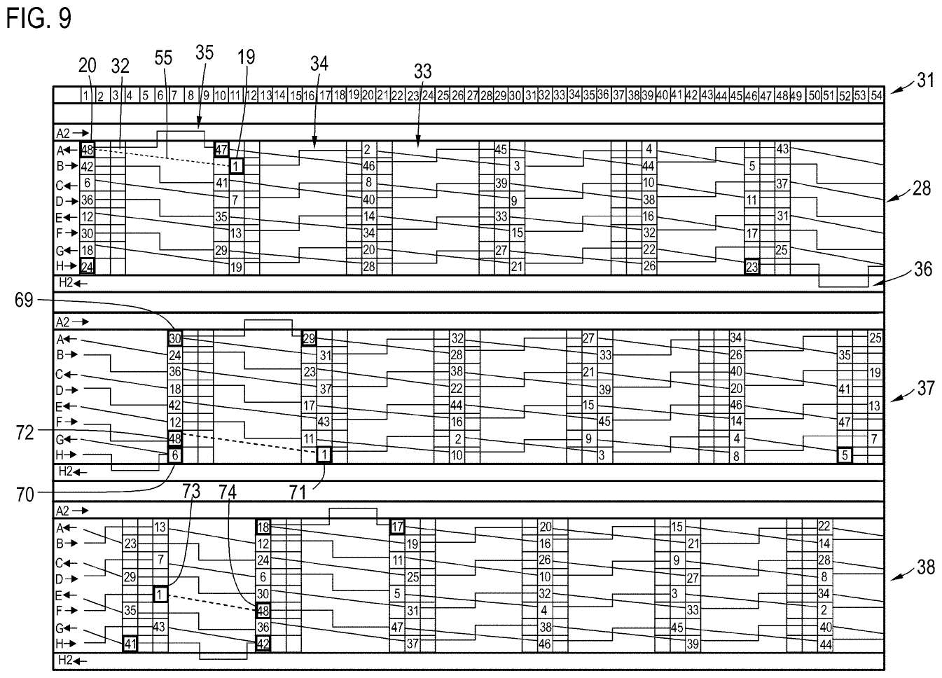

FIG. 9 shows windings 28, 37, 38 of different phases. The winding 28 herein is identical to the winding already shown in FIG. 8. Only one winding 37, 38 is shown for the remaining phases. The basic construction of the windings 37, 38 matches the construction of the winding 28, wherein the respective conductor for windings 28, 37, 38 of different phases is led through different ones of the grooves 31. Unnumbered boxes in the case of the windings 37, 38 also indicate specific winding layers in specific grooves in which other windings of the respective same phase which are not shown are led.

In order to minimize a voltage difference at intersections of the various phases and thus to reduce insulation requirements for the conductors, it is an advantage to arrange the connection points 19, 20 of the winding 28, the connection points 71, 72 of the winding 37, and the connection points 73, 74 of the winding 38 at different positions in the radial direction, that is, in different ones of the winding layers A to H. The should also be grouped in the circumferential direction to make contacting easier. As explained above, the windings can initially be formed as a conductor loop, whereafter a connection portion 55 can be disconnected as required to form the respective connection points at the position of the connection portion 55. The respective disconnected connection portion 55 is shown as a dashed line for the windings 28, 37, 38, which line connects the respective connections points 19, 20 or 71, 72, or 73, 74, respectively. Due to the fact that the connection portion 55 in the windings 37, 38 is disconnected in another portion of the winding, two reversing groove portions 69, 70 are respectively present in these windings 37, 38, at which the free end of the respective conductor hairpin that extends the respective groove portion 69, 70 is led in the same direction as the coupling portion.

The winding scheme shown also has the advantage that in the winding 38, starting from the connection point 73, a different direction of revolution is initially achieved for the current than for the windings 28, 37. This allows a further reduction of the voltage difference at intersecting conductors of the different windings 28, 37, 38.

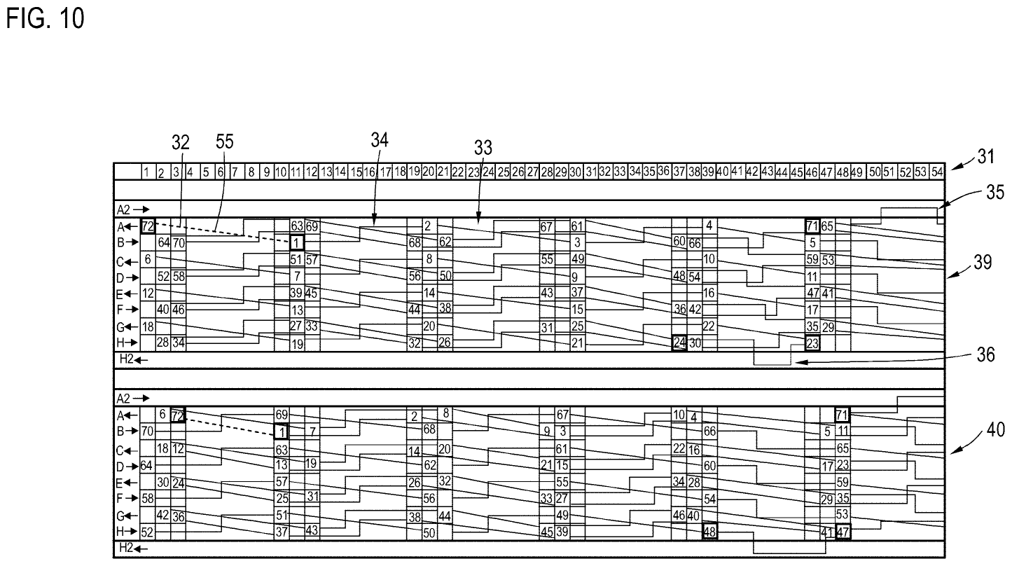

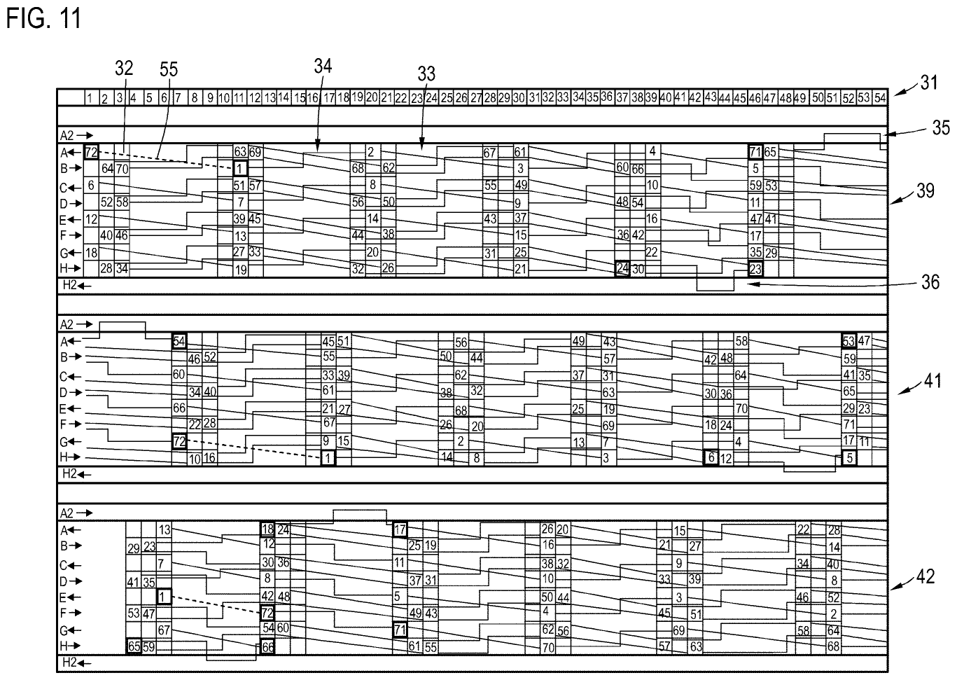

The procedure explained above for constructing the windings also allows to implement clearly changed winding schemes while using the same winding carrier. One example thereof is shown in is shown in FIGS. 10 and 11. As shown in FIG. 10, each phase comprises precisely two windings 39, 40. The arrangements of the windings 39, 41, 42 of different phases relative to each other are shown in FIG. 11 for illustration. It can be sufficient to use fewer windings per phase if lower currents are used for operating the electrical machine. Since only six windings are used in total, the respective conductor of the winding comprises more groove portions, and the boxes associated with the individual groove portions are numbered from 1 to 72. The boxes designated with numerals 1 and 72 thus indicate the positions of the connection points of the respective winding 39 to 42. As is visible in FIGS. 10 and 11, once again, using the connection portions 35, 36 led in the separate winding layers A2 and H2, the advantages are achieved that, by a respective selection of the positions of the connection points and the direction of revolution of the current, the connection points are spatially grouped, such that a simple connection is possible, wherein at the same time voltage differences between intersecting conductors of windings of different phases can be kept small.

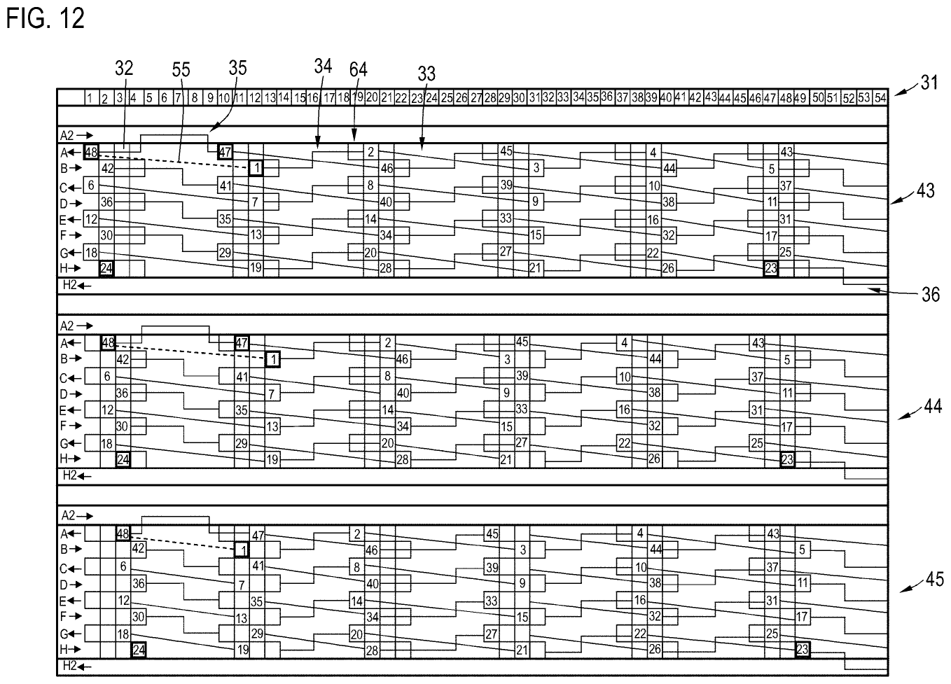

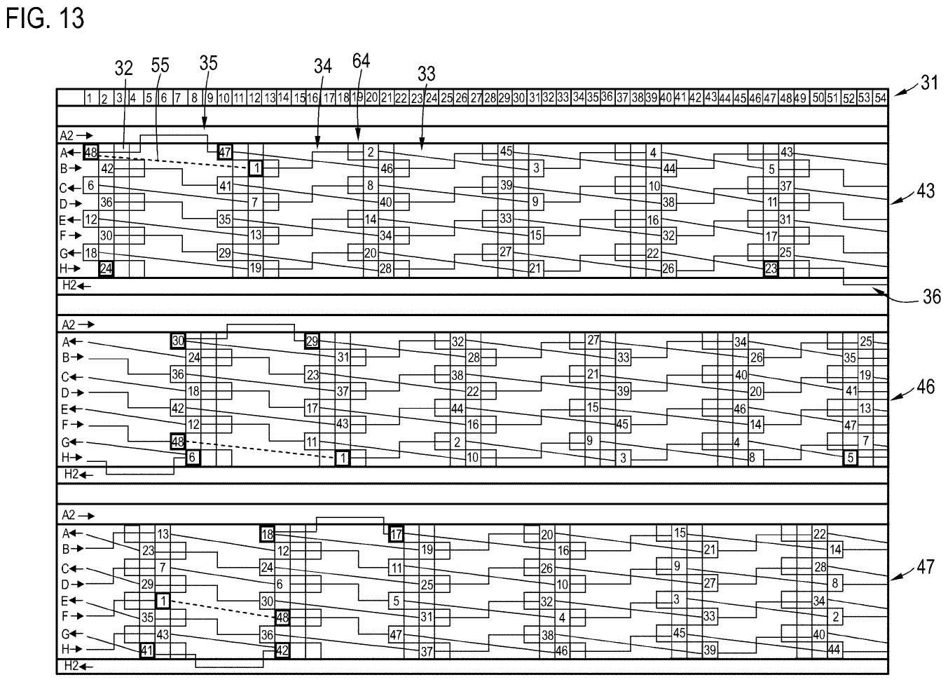

It can be an advantage to move the individual winding layers A to H of a winding relative to each other. This can help smooth an exciter curve and for example reduce harmonics of the induced voltage when a n electrical machine is operated as a generator. This is also called chording of a winding. The procedure described above makes it also easy to implement a chorded winding. A winding scheme for such a winding is shown in FIGS. 12 and 13, wherein FIG. 12 shows three windings 43, 44, 45 of a phase and FIG. 13 shows the arrangement of the windings 43, 46, 47 of different phases relative to each other. As can particularly be derived from FIG. 13, parts of the stacks 64 comprise groove portions of windings 43, 46, 47 of different phases in a chorded winding. Apart from moving the winding layers A to H of the windings 43 to 47 and the resulting variation in the length of the coupling portions of the conductor hairpins used, the general construction of the windings corresponds to the constructions explained with reference to FIGS. 8 to 11.

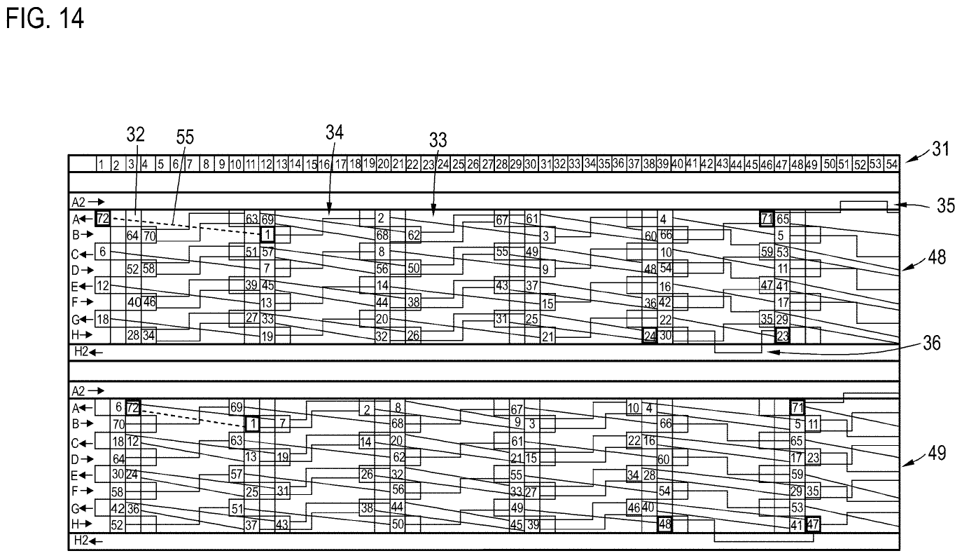

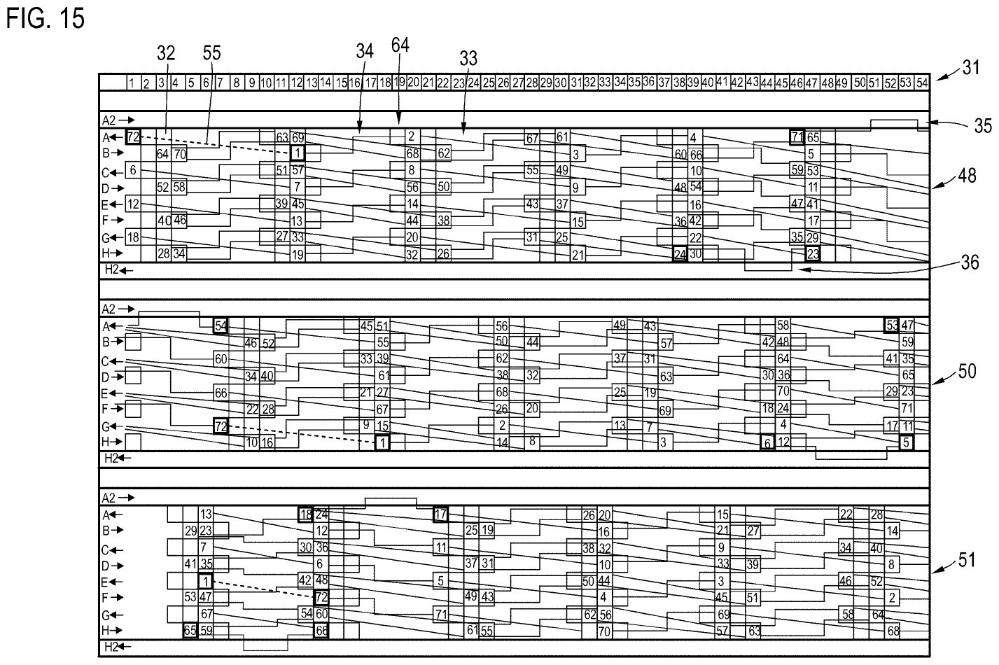

A chorded winding can also be implemented for an electrical machine in which the respective phases comprise precisely two windings 48, 49, as shown in FIGS. 14 and 15. FIG. 14 shows the two windings 48, 49 of one phase and FIG. 15 the arrangement of windings 48, 50, 51 of different phases relative to each other. Stacks 64 also occur here due to the chording of the winding, which stacks comprise groove portions of windings 48, 50, 51 of different phases. The procedure for constructing respective windings matches the procedure already explained with reference to FIGS. 8 to 13.

FIG. 16 shows an exemplary embodiment of a motor vehicle 56 according to the invention. The motor vehicle 56 comprises an electrical machine 52 which comprises a stator 53 which is constructed as explained above. A rotor 54 which is mounted for rotation about the axis of rotation 57 of the electrical machine 52 is arranged inside the stator 53. The electrical machine 52 can be a drive motor of the motor vehicle 56.

1-13. (canceled)

14. An electrical machine comprising a winding carrier which has multiple grooves and carries at least one winding, wherein the winding is formed by a respective conductor having multiple groove portions, each of which being led through one of the grooves of the winding carrier and conductively connected by connection portions of the conductor that lie outside the grooves, wherein, when current flows through the conductor in question from a first connection point to a second connection point of the winding in question, the current is led about an axis of rotation of the electrical machine with a first direction of revolution in all the connection portions that lie in a first conductor portion of said conductor, which first conductor portion comprises multiple connection portions, and with a second direction of revolution opposite the first direction of revolution in all the connection portions that lie in a second conductor portion of said conductor, which second conductor portion comprises a multiple connection portions, wherein the respective conductor is formed by multiple conductor hairpins conductively connected to each other, each of which forming two of the groove portions and one coupling portion connecting the groove portions, wherein the coupling portion forms a first connection portion for these groove portions, wherein a respective second connection portion is formed by a respective free end of the conductor hairpin, which end is bent into a direction in the circumferential direction of the winding carrier and conductively connected to a free end of another conductor hairpin,
wherein the conductor comprises at least one groove portion that is connected as a reversing groove portion via two connection portions to other groove portions of the conductor, which are led starting from the respective groove portion in the same direction in the circumferential direction of the winding carrier, wherein a stack of multiple groove portions stacked in the radial direction is arranged in the grooves, wherein, apart from one or two reversing groove portions of the respective conductor, the free ends of the conductor hairpins which extend groove portions arranged in the same radial position in the stacks are bent in the same direction in the circumferential direction of the winding carrier.

15. The electrical machine according to claim 14, wherein the first and/or the second conductor portion is led in a meandering manner at least once about the axis of rotation in the circumferential direction through the grooves of the winding carrier.

16. The electrical machine according to claim 14, wherein one stack of multiple radially stacked groove portions is arranged in the grooves, wherein the first and/or the second conductor portion of a respective conductor extend at least from a radially outermost groove portion of a stack to a radially innermost groove portion of the one or of another stack.

17. The electrical machine according to claim 14, wherein the stack of multiple groove portions stacked in the radial direction is arranged in each groove, wherein the reversing groove portion is the radially outermost groove portion of one of the stacks and one of the connection portions which connect the reversing groove portion to the other groove portions of the conductor is led radially outwards, or wherein the reversing groove portion is the radially innermost groove portion of one of the stacks and one of the connection portions which connect the reversing groove portion to the other groove portions of the conductor is led radially inwards.

18. The electrical machine according to claim 14, wherein apart from one or two reversing groove portions of the respective conductor and groove portions of the conductor which are adjacent to the connection points, all groove portions of the conductor are connected via two connection portions to other groove portions of the conductor which, starting from the respective groove portion, are led into opposing directions in the circumferential direction of the winding carrier.

19. The electrical machine according to claim 14, wherein the winding carrier carries a first winding of a first phase of the electrical machine and a second winding of a second phase of the electrical machine, wherein those groove portions at which the first and/or the second connection point of the first winding is formed are arranged on another radius with respect to the axis of rotation of the electrical machine than those groove portions at which the first and/or the second connection point of the second winding is formed.

20. The electrical machine according to claim 14, wherein the winding carrier carries the or a first winding of the or a first phase of the electrical machine and the or a second winding the or a second phase of the electrical machine, wherein, when a current flows through the respective conductor from the first connection point to the second connection point of the respective winding, the current is led in the connection portions of a first terminal portion of the conductor of the first winding, which comprises the first connection point of the first winding, in a direction of revolution about the axis of rotation of the electrical machine which is opposite to the direction of revolution with which the current is led in the connection portions of a second terminal portion of the conductor of the second winding, which comprises the first connection point of the second winding.

21. A vehicle, the vehicle comprises an electrical machine according to claim 14.

22. A method for producing at least one winding for an electrical machine, comprising the steps:
providing a winding carrier and multiple conductor hairpins, each of which is formed from a hairpin-shaped conductor portion and forming the respective two groove portions and a coupling portion connecting the groove portions, wherein the coupling portion forms a first connection portion for these groove portions,
axially inserting the conductor hairpins into the winding carrier such that the two groove portions of each conductor hairpin run in a respective groove of the winding carrier, and
bending the free ends of the conductor hairpins into a respective direction in the circumferential direction of the winding carrier and connecting to a free end of a respective other conductor hairpin to form the conductor from the conductor portions, wherein a free end of at least one conductor hairpin is bent in the same direction in the circumferential direction of the winding carrier into which a coupling portion connecting the groove portions of this conductor hairpin extends as well, such that the conductor comprises at least one groove portion that is connected as a reversing groove portion via two connection portions to other groove portions of the conductor, which are led starting from the respective groove portion in the same direction in the circumferential direction of the winding carrier, wherein a stack of multiple groove portions stacked in the radial direction is arranged in the grooves, wherein, apart from one or two reversing groove portions of the respective conductor, the free ends of the conductor hairpins which extend groove portions arranged in the same radial position in the stacks are bent in the same direction in the circumferential direction of the winding carrier.

23. The method according to claim 22, wherein the free ends of the conductor hairpins of a winding are first connected to each other, such that a closed conductor loop is formed, whereafter the connection between two free ends is disconnected or a coupling portion of one of the conductor hairpins is disconnected to form first and second connection points of the winding.

24. The electrical machine according to claim 14, wherein one stack of multiple radially stacked groove portions is arranged in the grooves, wherein the first and/or the second conductor portion of a respective conductor extend at least from a radially outermost groove portion of a stack to a radially innermost groove portion of the one or of another stack.

25. The electrical machine according to claim 15, wherein the stack of multiple groove portions stacked in the radial direction is arranged in each groove, wherein the reversing groove portion is the radially outermost groove portion of one of the stacks and one of the connection portions which connect the reversing groove portion to the other groove portions of the conductor is led radially outwards, or wherein the reversing groove portion is the radially innermost groove portion of one of the stacks and one of the connection portions which connect the reversing groove portion to the other groove portions of the conductor is led radially inwards.

26. The electrical machine according to claim 16, wherein the stack of multiple groove portions stacked in the radial direction is arranged in each groove, wherein the reversing groove portion is the radially outermost groove portion of one of the stacks and one of the connection portions which connect the reversing groove portion to the other groove portions of the conductor is led radially outwards, or wherein the reversing groove portion is the radially innermost groove portion of one of the stacks and one of the connection portions which connect the reversing groove portion to the other groove portions of the conductor is led radially inwards.

27. The electrical machine according to claim 15, wherein apart from one or two reversing groove portions of the respective conductor and groove portions of the conductor which are adjacent to the connection points, all groove portions of the conductor are connected via two connection portions to other groove portions of the conductor which, starting from the respective groove portion, are led into opposing directions in the circumferential direction of the winding carrier.

28. The electrical machine according to claim 16, wherein apart from one or two reversing groove portions of the respective conductor and groove portions of the conductor which are adjacent to the connection points, all groove portions of the conductor are connected via two connection portions to other groove portions of the conductor which, starting from the respective groove portion, are led into opposing directions in the circumferential direction of the winding carrier.

29. The electrical machine according to claim 17, wherein apart from one or two reversing groove portions of the respective conductor and groove portions of the conductor which are adjacent to the connection points, all groove portions of the conductor are connected via two connection portions to other groove portions of the conductor which, starting from the respective groove portion, are led into opposing directions in the circumferential direction of the winding carrier.

30. The electrical machine according to claim 15, wherein the winding carrier carries a first winding of a first phase of the electrical machine and a second winding a second phase of the electrical machine, wherein those groove portions at which the first and/or the second connection point of the first winding is formed are arranged on another radius with respect to the axis of rotation of the electrical machine than those groove portions at which the first and/or the second connection point of the second winding is formed.

31. The electrical machine according to claim 16, wherein the winding carrier carries a first winding of a first phase of the electrical machine and a second winding a second phase of the electrical machine, wherein those groove portions at which the first and/or the second connection point of the first winding is formed are arranged on another radius with respect to the axis of rotation of the electrical machine than those groove portions at which the first and/or the second connection point of the second winding is formed.

32. The electrical machine according to claim 17, wherein the winding carrier carries a first winding of a first phase of the electrical machine and a second winding of a second phase of the electrical machine, wherein those groove portions at which the first and/or the second connection point of the first winding is formed are arranged on another radius with respect to the axis of rotation of the electrical machine than those groove portions at which the first and/or the second connection point of the second winding is formed.

33. The electrical machine according to claim 18, wherein the winding carrier carries a first winding of a first phase of the electrical machine and a second winding of a second phase of the electrical machine, wherein those groove portions at which the first and/or the second connection point of the first winding is formed are arranged on another radius with respect to the axis of rotation of the electrical machine than those groove portions at which the first and/or the second connection point of the second winding is formed.
